(19) United States
(12) Patent Application Publication
(10) Pub. No.: US 2025/0170691 A1
(43) Pub. Date: May 29, 2025

(54) HIGH-INTENSITY MAGNETIC BIT EXTENSION ROD WITH TELESCOPIC UNLOCKING FUNCTION

(71) Applicants: Xiaofeng ZHANG, Zhenjiang (CN); DANYANG JIANLU TOOLS CO., LTD., Zhenjiang (CN)

(72) Inventors: Xiaofeng ZHANG, Zhenjiang (CN); Ning JIANG, Zhenjiang (CN)

(73) Assignees: Xiaofeng ZHANG, Zhenjiang (CN); DANYANG JIANLU TOOLS CO., LTD., Zhenjiang (CN)

(21) Appl. No.: 18/775,783

(22) Filed: Jul. 17, 2024

(30) Foreign Application Priority Data
Nov. 23, 2023 (CN) 202311574483.1

(51) Int. Cl. B25B 23/12; B25B 23/00

(52) U.S. Cl. CPC B25B 23/12; B25B 23/0035

(57) ABSTRACT

A high-intensity magnetic bit extension rod with a telescopic unlocking function is provided, which includes a connecting rod sleeve, a magnet, and a connecting rod handle, where a tool bit sleeve configured to connect a tool bit is disposed at a front end of the connecting rod sleeve, a slidable limiting tubing is disposed at a rear end of the connecting rod sleeve, the magnet is disposed at a front end of the connecting rod handle, and a partition structure or/and a magnetic conduction structure is/are further disposed between the magnet and a bottom of the tool bit sleeve; and the connecting rod sleeve and the slidable limiting tubing are synchronously axially slidable relative to the connecting rod handle and the magnet.

### CROSS-REFERENCE TO RELATED APPLICATIONS

This application claims priority to Chinese Application No. 202311574483.1, having a filing date of Nov. 23, 2023, the entire contents of which are hereby incorporated by reference.

### TECHNICAL FIELD

This application relates to the field of hand-powered and electric tool technologies, and specifically to a high-intensity magnetic bit extension rod with a telescopic unlocking function.

### BACKGROUND OF THE INVENTION

In the related art, a bit with magnetism is usually used to attract a screw. During the use of an extension rod, the magnetism of the bit mainly comes from a magnet disposed in the extension rod at which the bit is mounted. To improve a screw supporting effect, the magnetism of the magnet needs to be increased as much as possible for the magnetic bit. However, as a result, during the replacement of the bit, it requires a large force to separate the bit from the extension rod. Some bits have small exposed parts, and the shapes of many models make it difficult to pinch and pull out a bit with a hand. Therefore, when a tool bit is tightly attracted by a magnetic force, it may even be necessary to use pliers or another tool.

To resolve the foregoing problem, in the related art, the attraction of a bit by a magnet is usually reduced by manipulating the magnet to move in a direction away from the bit first, and then the bit is pulled out to separate the bit from an extension rod.

The related art discloses a manner of adding a magnet drive apparatus to a lateral portion of an extension rod to control a magnet to move in the extension rod. The magnet drive apparatus includes a directly driven sliding sleeve and a slope-driven button. It is relatively difficult to perform replacement with one hand. When the magnet has a relatively large magnetic force, the operation of pushing a toggle with a hand is very difficult, and the hand may be injured after repeated operations.

After the magnet is separated from the bit, it is still necessary to press the magnet drive apparatus (the sliding sleeve and the button) with a hand, or otherwise the magnet slides to the bit again. As a result, during actual use by a worker, instead of using one hand, both hands are required to replace the bit.

Moreover, because the magnet drive apparatus is disposed at the lateral portion of the extension rod, an outer diameter of a front end of the foregoing existing structure is increased, which is not conducive to use in a small space, and causes a result that a radial size of an internal magnet can only be relatively small. It is found through research that when the thickness of the magnet reaches a particular size, the diameter of the magnet is a key factor that affects a magnetic attraction effect. Therefore, a magnet with a small diameter cannot meet a use requirement of supporting a screw erect, and is also easily thrown off from an electric tool with high-speed rotation, and especially at a heavy operating condition, a large screw cannot be attracted tightly.

### SUMMARY OF THE INVENTION

To resolve the deficiencies in the related art, this application provides a high-intensity magnetic bit extension rod with a telescopic unlocking function, to mainly resolve the technical problem that it is not convenient to replace a bit in an extension rod.

To achieve the foregoing objective, the following technical solution is adopted in this application.

A high-intensity magnetic bit extension rod with a telescopic unlocking function includes a connecting rod sleeve, a magnet, and a connecting rod handle, where a tool bit sleeve configured to connect a tool bit is disposed at a front end of the connecting rod sleeve, a slidable limiting tubing is disposed at a rear end of the connecting rod sleeve, the magnet is disposed at a front end of the connecting rod handle, and a partition structure or/and a magnetic conduction structure is/are further disposed between the magnet and a bottom of the tool bit sleeve; and the connecting rod sleeve and the slidable limiting tubing are synchronously axially slidable relative to the connecting rod handle and the magnet.

Preferably, in the high-intensity magnetic bit extension rod with a telescopic unlocking function, a positioning structure configured to keep the magnet at a position away from a bit is disposed between the slidable limiting tubing and the connecting rod handle.

As a preferred implementation of this application, the partition structure is configured to constrain a depth by which the tool bit is inserted into the tool bit sleeve, and the partition structure includes one or a combination of a plurality of a fixed stop, an inner hole annular partition, and a positioning pin partition that are fixed at the bottom of the tool bit sleeve.

As a preferred implementation of this application, the magnetic conduction structure is a T-shaped slidable stop.

As a preferred implementation of this application, when the partition structure is the fixed stop, a spacer configured to keep the fixed stop and the magnet spaced apart is further disposed therebetween.

As a preferred implementation of this application, when the partition structure is the inner hole annular partition, the T-shaped slidable stop axially slidable relative to the sleeve is further disposed in the inner hole annular partition, and the T-shaped slidable stop has a larger-diameter end attracted to an end portion of the magnet and a smaller-diameter end matching the inner hole annular partition.

As a preferred implementation of this application, when the partition structure is the inner hole annular partition, the T-shaped slidable stop is a magnet located at the front end of the rod handle, and the T-shaped slidable stop has a larger-diameter end connected to the front end of the rod handle and a smaller-diameter end matching the inner hole annular partition.

As a preferred implementation of this application, the positioning structure includes a shaft stop disposed on an outer surface of the connecting rod handle and a tapered hole provided in an inner hole of the slidable limiting tubing, the shaft stop has an elastic force relative to the tapered hole, the elastic force has a direction away from the center of circle of the connecting rod handle, when the tool bit is at a position far away from the magnet, the shaft stop is located at a smaller-diameter portion of the tapered hole, and when the tool bit is at a position near the magnet, the shaft stop is located at a larger-diameter portion of the tapered hole.

As a preferred implementation of this application, the connecting rod handle is connected to the connecting rod sleeve and the slidable limiting tubing by a connecting rod handle tube connecting section, an outer diameter of the connecting rod handle tube connecting section is larger than that of a tool connecting end of the connecting rod handle, an outer portion of the connecting rod handle tube connecting section is connected to the connecting rod sleeve through form locking, and a shaft stop limits an axial position of the connecting rod sleeve.

As a preferred implementation of this application, a minimum outer diameter of a connecting rod handle tube connecting section is larger than a diameter of the magnet, and the diameter of the magnet is larger than a minimum outer diameter of the connected tool bit.

As a preferred implementation of this application, the connecting rod sleeve is made of a non-conducting magnet material, and the connecting rod handle is made of a conducting magnet material.

As a preferred implementation of this application, a material of the fixed stop is iron, and the spacer is made of a non-magnetically conductive material.

Beneficial effects achieved by this application: Compared with the related art, in this application, in a process of replacing the bit, the magnet may be driven to the position away from the bit in a sliding manner and kept at the position by the positioning structure. In this way, an operator can easily pull out the bit with one hand.

The slidable limiting tubing of this application is located at the rear end of the connecting rod sleeve, so that in one aspect, the diameter of the magnet inside the connecting rod sleeve can be made as large as possible to increase a magnetic attraction capability, and in another aspect, an outer diameter of the front end of the connecting rod sleeve can be reduced to facilitate use in a small space.

In this application, a non-conducting magnet material is chosen for the connecting rod sleeve, a conducting magnet material is chosen for the connecting rod handle, and the connecting rod handle and the bit at two ends of the magnet can enhance the distribution of a magnetic field at the two ends of the magnet, so that the magnetic field can better extend to an end portion of the bit, thereby increasing a screw supporting capability.

### BRIEF DESCRIPTION OF DRAWINGS

FIG. 1 is a cross-sectional view of Embodiment 1;

FIG. 2 is a comparison diagram of different attraction states of a bit of Embodiment 1;

FIG. 3 is a cross-sectional view of Embodiment 2;

FIG. 4 is a comparison diagram of different attraction states of a bit of Embodiment 3, in which T-shaped slidable stop is a material of iron;

FIG. 5 is a comparison diagram of different attraction states of a bit of Embodiment 3, in which T-shaped slidable stop is a magnet;

FIG. 6 is a cross-sectional view of Embodiment 4;

FIG. 7 is a comparison diagram of different attraction states of a bit of Embodiment 4;

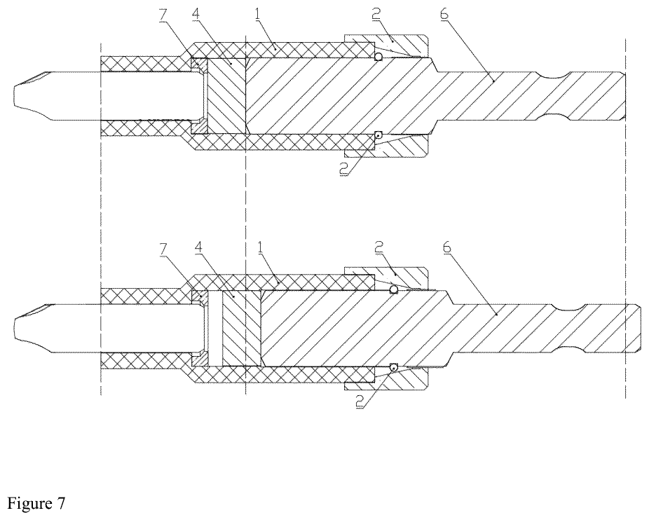

FIG. 8 is a partial enlarged view of A in FIG. 6;

FIG. 9 is a partial enlarged view of B in FIG. 6;

FIG. 10 is a structural diagram showing connection between a connecting rod handle tube connecting section and a shaft stop.

FIG. 11 is a schematic diagram showing the distribution of magnetic field lines

Meanings of reference numerals: 1—connecting rod sleeve; 2—slidable limiting tubing; 3—fixed stop; 4—magnet; 5—shaft stop; 6—connecting rod handle; 11—tool bit sleeve; 12—connecting rod handle connecting sleeve; 21—tapered hole; 61—connecting rod handle tube connecting section; 62—annular groove; 7—inner hole annular partition; 8—spacer; and 9—T-shaped slidable stop.

### DETAILED DESCRIPTION OF THE INVENTION

The following further describes this application in detail with reference to the accompanying drawings. The following embodiments are only used for describing the technical solutions of this application more clearly, but cannot be used to limit the scope of protection of this application.

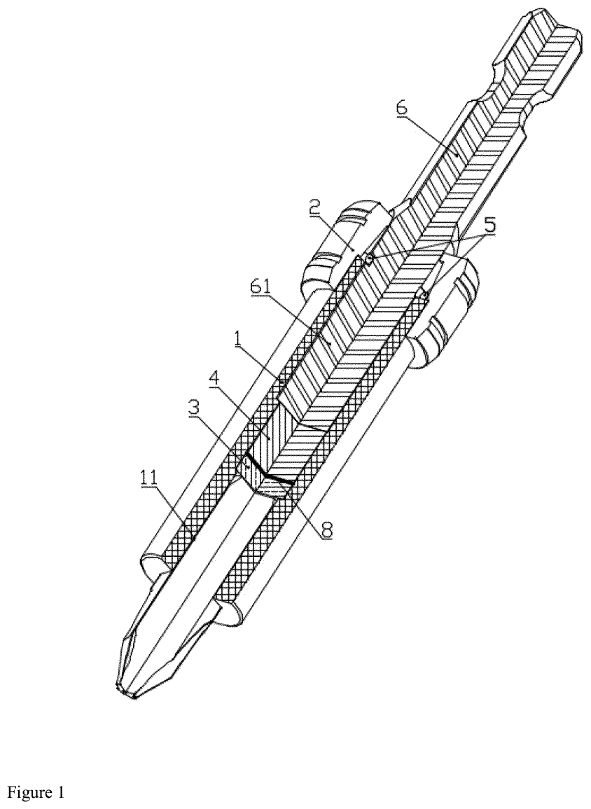

As shown in FIG. 1, this application discloses a high-intensity magnetic bit extension rod with a telescopic unlocking function, including a connecting rod sleeve 1, a magnet 4, and a connecting rod handle 6. A tool bit sleeve 11 configured to connect a tool bit is disposed at a front end of the connecting rod sleeve 1. A slidable limiting tubing 2 is disposed at a rear end of the connecting rod sleeve 1. The magnet 4 is disposed at a front end of the connecting rod handle 6. In this application, the “front end” is an end of the entire high-intensity magnetic bit extension rod with a telescopic unlocking function close to a bit, and the “rear end” is an end close to a tool. The “front end” and the “rear end” are only used for ease of describing the implementations recorded in this application, and are not intended to limit the scope of protection of this application.

A partition structure or/and a magnetic conduction structure is/are further disposed between the magnet 4 and a bottom of the tool bit sleeve 11. In other words, approximately three forms of structures may be provided between the magnet 4 and the bottom of the tool bit sleeve 11: the partition structure is provided, the magnetic conduction structure is provided, or both the partition structure and the magnetic conduction structure are provided. It is to be noted that the partition structure needs to constrain a depth by which the tool bit is inserted into the tool bit sleeve 11. Therefore, when any form of the foregoing three structures is used, a corresponding limiting structure needs to be provided at a bottom of the bit.

The connecting rod sleeve 1 and the slidable limiting tubing 2 are synchronously axially slidable relative to the connecting rod handle 6 and the magnet 4. In other words, the connecting rod sleeve 1 and the slidable limiting tubing 2 are fixedly connected and may be referred to as an external structure, and the connecting rod handle 6 and the magnet 4 are fixed together and may be referred to as an internal structure. The internal structure and the external structure can axially slide within a particular range. For ease of description, a state in which the internal structure and the external structure slide to make the magnet 4 away from the bit is referred to as a released state, and a state in which the internal structure and the external structure slide to make the magnet 4 closest to the bit is referred to as a locked state.

A positioning structure configured to keep the magnet 4 at a position away from the bit is disposed between the slidable limiting tubing 2 and the connecting rod handle 6. In other words, when the internal structure and the external structure slide relatively to the released state, the positioning structure may provide a force making the internal structure and the external structure tend to be kept in the released state. With the presence of the positioning structure, when the internal structure and the external structure slide to the released state, the magnet 4 is away from the bit. In this way, the bit can be easily inserted, removed, or replaced. It is to be noted that although the magnet 4 has a very small attractive force to the bit in the released state, the attractive force still exists, and the bit is kept inside the tool bit sleeve 11 by the small attractive force, to prevent the bit from falling off the tool bit sleeve 11.

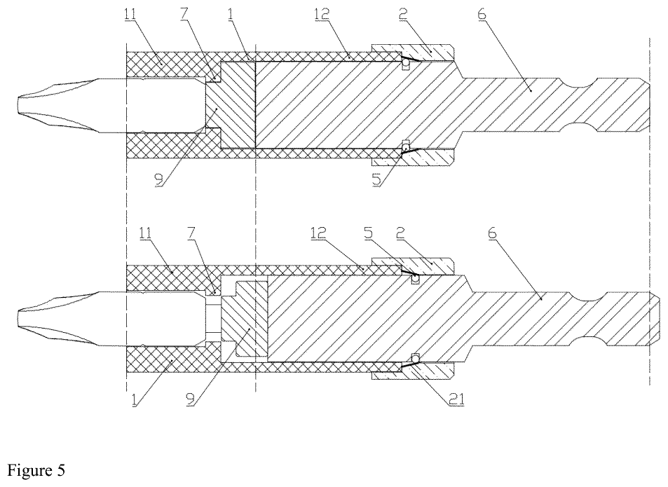

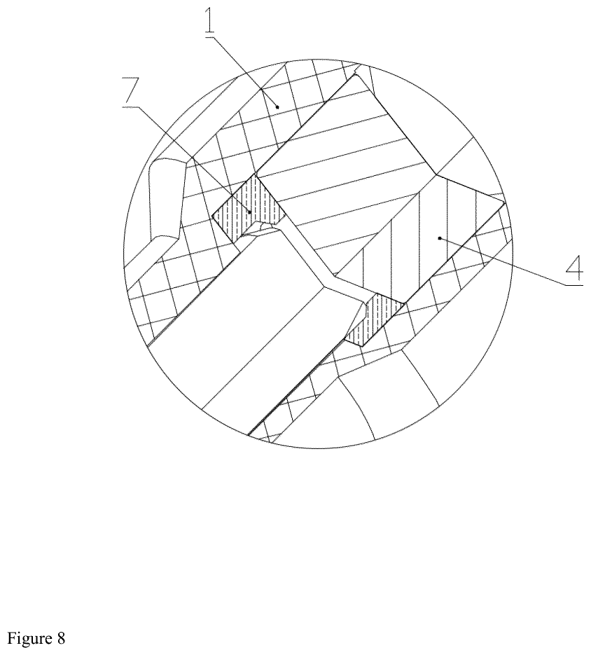

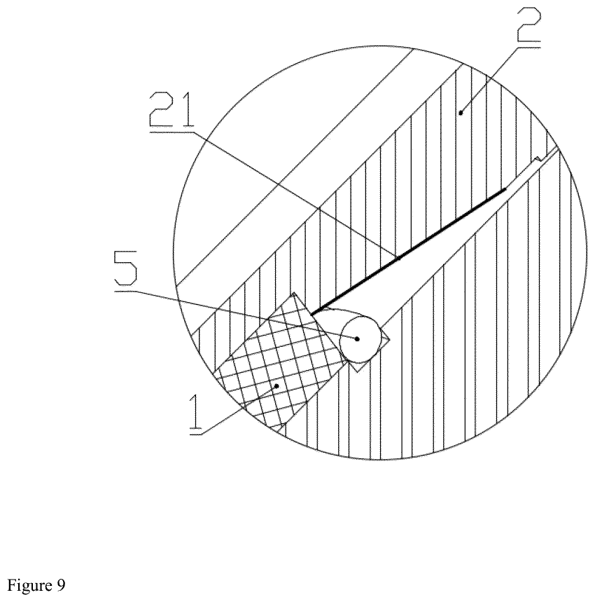

With reference to FIG. 5, FIG. 8, and FIG. 9, the positioning structure includes a shaft stop 5 disposed on an outer surface of the connecting rod handle 6 and a tapered hole 21 provided in an inner hole of the slidable limiting tubing 2. The shaft stop 5 has an elastic force that has a direction away from the center of circle of the connecting rod handle 6 relative to the tapered hole 21, and the elastic force is applied to a tapered inner hole of the tapered hole 21. When the tool bit is at a position far away from the magnet 4 (i.e., in the released state), the shaft stop 5 is located at a smaller-diameter portion of the tapered hole 21, and when the tool bit is at a position near the magnet 4 (i.e., in the locked state), the shaft stop 5 is located at a larger-diameter portion of the tapered hole 21.

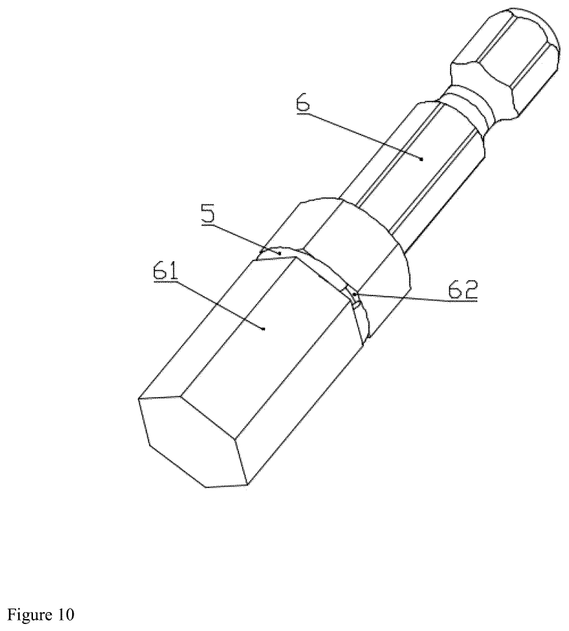

As shown in FIG. 10, in consideration of the mounting and attraction effects of the magnet 4, an inner diameter of the connecting rod sleeve 1 needs to be relatively large. Therefore, the connecting rod handle 6 is connected to the connecting rod sleeve 1 and the slidable limiting tubing 2 by a connecting rod handle tube connecting section 61, and an outer diameter of the connecting rod handle tube connecting section 61 is larger than that of a tool connecting end of the connecting rod handle 6. A cross section of the connecting rod handle tube connecting section 61 is usually a regular hexagon, and a minimum outer diameter (a distance between a pair of opposite sides) of the connecting rod handle tube connecting section is larger a diameter of the magnet 4, and the diameter of the magnet 4 is larger than a minimum outer diameter of the connected tool bit. In this way, the magnet 4 can provide a large attractive force to the tool bit, and it can also be ensured that the magnet 4 is normally mounted inside the tool bit sleeve 11.

An outer portion of the connecting rod handle tube connecting section 61 is connected to the connecting rod sleeve 1 through form locking, so that the transfer of torque can be achieved. The connecting rod handle tube connecting section 61 can be designed as a regular hexagon. In addition, the shaft stop 5 limits an axial connection position of the connecting rod handle tube connecting section 61.

In a practical application, an annular groove 62 may be provided on the outer portion of the connecting rod handle tube connecting section 61, the shaft stop 5 is disposed inside the annular groove 62, and the shaft stop 5 is axially constrained by the annular groove 62.

The partition structure includes one or a combination of more than one of a fixed stop 3, an inner hole annular partition 7, and a positioning pin partition that are fixed at the bottom of the tool bit sleeve 11. The magnetic conduction structure is a T-shaped slidable stop 9.

The partition structure or/and the magnetic conduction structure in this application has/have a plurality of implementations as follows:

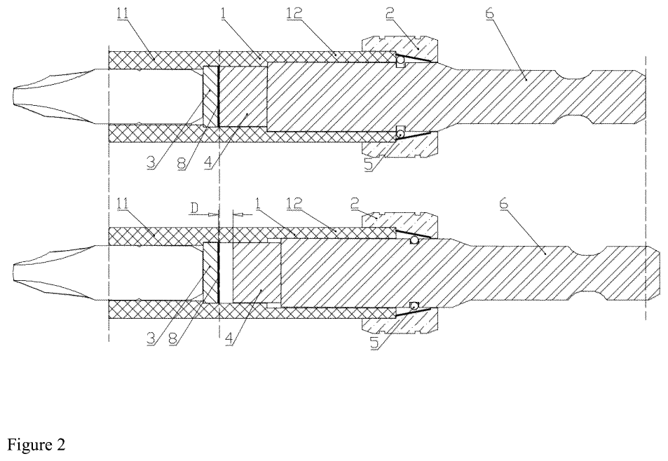

Embodiment 1: Refer to FIG. 1 and FIG. 2.

When the partition structure is the fixed stop 3, a material of the fixed stop is

preferably iron. A spacer 8 configured to keep the fixed stop 3 and the magnet 4 spaced apart is further disposed therebetween. The spacer 8 reduces the attraction between the magnet 4 and the fixed stop 3 by avoiding direct contact (keeping a distance) between the magnet 4 and the fixed stop 3, to enable the magnet 4 to remain attached to an end portion of the connecting rod handle 6.

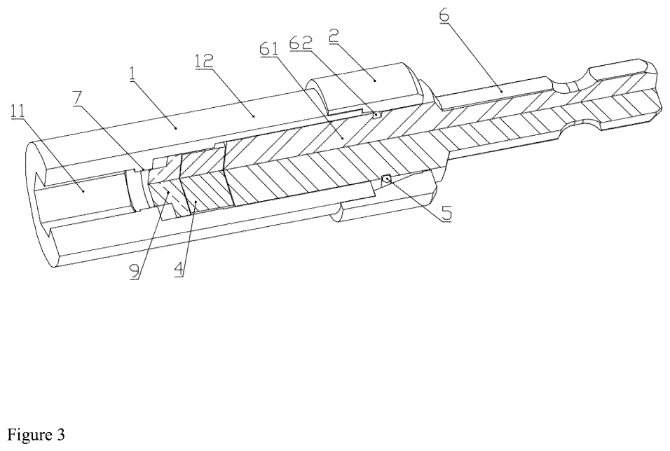

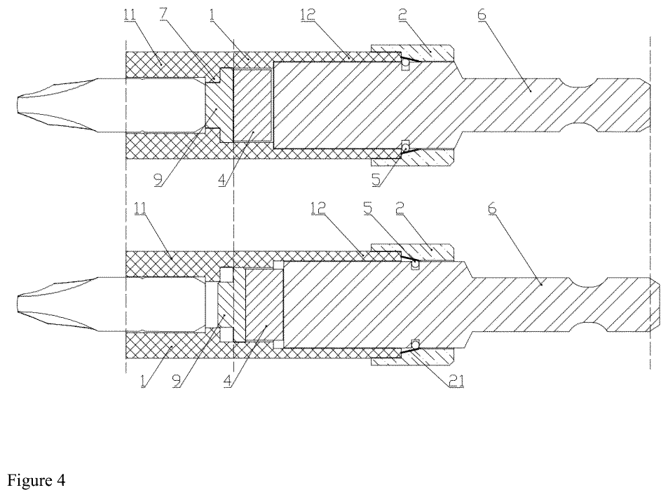

Embodiment 2: Refer to FIG. 3 and FIG. 4.

When the partition structure is the inner hole annular partition 7, the T-shaped slidable stop 9 axially slidable relative to the sleeve 1 is further disposed in the inner hole annular partition 7, and the T-shaped slidable stop 9 has a larger-diameter end attracted to an end portion of the magnet 4 and a smaller-diameter end matching the inner hole annular partition 7. The T-shaped slidable stop 9 usually has a material of iron and is attracted at the end portion of the magnet 4, and is configured to transfer the magnetism generated by the magnet 4 to an end portion of the bit. In addition, the larger-diameter end of the T-shaped slidable stop 9 is attracted to the end portion of the magnet 4, so that the T-shaped slidable stop 9 can remain attracted at the end portion of the magnet 4.

Embodiment 3: Refer to FIG. 5.

When the partition structure is the inner hole annular partition 7, the T-shaped slidable stop 9 is a magnet located at the front end of the rod handle 6, and the T-shaped slidable stop 9 has a larger-diameter end connected to the front end of the rod handle 6 and a smaller-diameter end matching the inner hole annular partition 7. The larger-diameter end of the T-shaped slidable stop 9 is attracted to the front end of the rod handle 6, so that the T-shaped slidable stop 9 can remain attracted at the end portion of the rod handle 6.

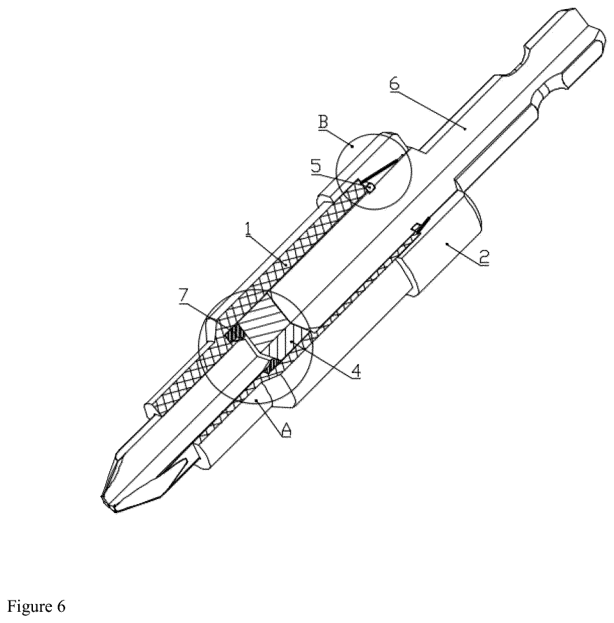

Embodiment 4: Refer to FIG. 6 and FIG. 8.

The partition structure may be the inner hole annular partition 7. The magnet 4 is directly attracted at the end portion of the connecting rod handle 6. When the partition structure is the inner hole annular partition 7, a contact area between a tail portion of the tool bit and the magnet 4 is smaller than a contact area between the magnet 4 and the connecting rod handle 6. Therefore, when the connecting rod handle 6 and the connecting rod sleeve 1 slide relatively, the magnet 4 remains attracted at the end portion of the connecting rod handle 6 and moves along synchronously. Therefore, the magnet 4 remains attracted at the end portion of the connecting rod handle 6.

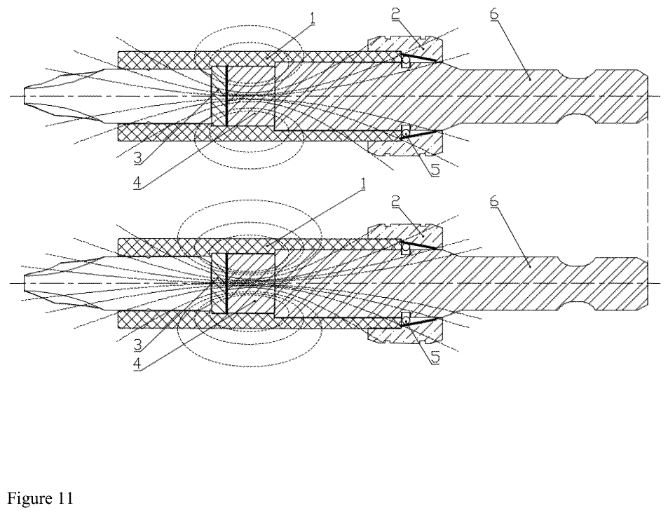

In this application, a non-conducting magnet material is preferably chosen for the connecting rod sleeve 1, a conducting magnet material is preferably chosen for the connecting rod handle 6. As shown in FIG. 11, the lower figure of FIG. 11 represents that a non-conducting magnet material is chosen for the connecting rod sleeve 1 and a conducting magnet material is chosen for the connecting rod handle 6, and the upper figure of FIG. 11 represents that a non-conducting magnet material is not chosen for the connecting rod sleeve 1 or a non-conducting magnet material is chosen for the connecting rod handle 6.

Dash lines in FIG. 11 represents the distribution of magnetic field lines. First, when a non-conducting magnet material is chosen for the connecting rod sleeve 1, the impact on the distribution of magnetic field lines is small, or even no impact is caused, and the connecting rod handle 6 and the bit at two ends of the magnet 4 are both made of a magnetically conductive material. For a cylindrical magnet, magnetic field lines of the cylindrical magnet leave one end surface to reach the other end surface. Magnetic conduction structures are disposed at both end surfaces, which better facilitates the formation of magnetic field line loops. Therefore, the foregoing magnetic field lines can be “stretched” in an axial direction of the entire extension rod, so that the magnetic field can better “converge” to the bit and the end portion of the bit, thereby improving a magnetic field direction, and improving a screw supporting effect.

When it is necessary to replace a bit with a longer one, an increase in a bit length does not significantly reduce the magnetism at a front end of the bit.

Compared with the related art, in this application, in a process of replacing the bit, the magnet 4 may be driven to the position away from the bit in a sliding manner and kept at the position by the positioning structure. In this way, an operator can easily pull out the bit with one hand.

The slidable limiting tubing of this application is located at the rear end of the connecting rod sleeve 1, so that in one aspect, the diameter of the magnet 4 inside the connecting rod sleeve 1 can be made as large as possible to increase a magnetic attraction capability, and in another aspect, an outer diameter of the front end of the connecting rod sleeve 1 can be reduced to facilitate use in a small space.

In this application, a non-conducting magnet material is chosen for the connecting rod sleeve 1, a conducting magnet material is chosen for the connecting rod handle 6, and the connecting rod handle 6 and the bit at two ends of the magnet 4 can enhance the distribution of a magnetic field at the two ends of the magnet 4, so that the magnetic field can better extend to an end portion of the bit, thereby increasing a screw supporting capability.

The foregoing descriptions are merely exemplary implementations of this application. A person of ordinary skill in the art may further make several improvements and variations without departing from the technical principle of this application, and the improvements and variations fall within the scope of protection of this application.

1. A high-intensity magnetic bit extension rod with a telescopic unlocking function, comprising a connecting rod sleeve (1), a magnet (4), and a connecting rod handle (6), wherein a tool bit sleeve (11) configured to connect a tool bit is disposed at a front end of the connecting rod sleeve (1), a slidable limiting tubing (2) is disposed at a rear end of the connecting rod sleeve (1), the magnet (4) is disposed at a front end of the connecting rod handle (6), and a partition structure or/and a magnetic conduction structure is/are further disposed between the magnet (4) and a bottom of the tool bit sleeve (11); and
the connecting rod sleeve (1) and the slidable limiting tubing (2) are synchronously axially slidable relative to the connecting rod handle (6) and the magnet (4).

2. The high-intensity magnetic bit extension rod with a telescopic unlocking function according to claim 1, wherein a positioning structure configured to keep the magnet (4) at a position away from a bit is disposed between the slidable limiting tubing (2) and the connecting rod handle (6).

3. The high-intensity magnetic bit extension rod with a telescopic unlocking function according to claim 1, wherein the partition structure is configured to constrain a depth by which the tool bit is inserted into the tool bit sleeve (11), and the partition structure comprises one or a combination of a plurality of a fixed stop (3), an inner hole annular partition (7), and a positioning pin partition that are fixed at the bottom of the tool bit sleeve (11).

4. The high-intensity magnetic bit extension rod with a telescopic unlocking function according to claim 3, wherein the magnetic conduction structure is a T-shaped slidable stop (9).

5. The high-intensity magnetic bit extension rod with a telescopic unlocking function according to claim 3, wherein when the partition structure is the fixed stop (3), a spacer (8) configured to keep the fixed stop (3) and the magnet (4) spaced apart is further disposed therebetween.

6. The high-intensity magnetic bit extension rod with a telescopic unlocking function according to claim 4, wherein when the partition structure is the inner hole annular partition (7), the T-shaped slidable stop (9) axially slidable relative to the connecting rod sleeve (1) is further disposed in the inner hole annular partition (7), and the T-shaped slidable stop (9) has a larger-diameter end attracted to an end portion of the magnet (4) and a smaller-diameter end matching the inner hole annular partition (7).

7. The high-intensity magnetic bit extension rod with a telescopic unlocking function according to claim 4, wherein when the partition structure is the inner hole annular partition (7), the T-shaped slidable stop (9) is a magnet located at the front end of the connecting rod handle (6), and the T-shaped slidable stop (9) has a larger-diameter end connected to the front end of the rod handle (6) and a smaller-diameter end matching the inner hole annular partition (7).

8. The high-intensity magnetic bit extension rod with a telescopic unlocking function according to claim 2, wherein the positioning structure comprises a shaft stop (5) disposed on an outer surface of the connecting rod handle (6) and a tapered hole (21) provided in an inner hole of the slidable limiting tubing (2), the shaft stop (5) has an elastic force relative to the tapered hole (21), the elastic force has a direction away from the center of circle of the connecting rod handle (6), when the tool bit is at a position far away from the magnet (4), the shaft stop (5) is located at a smaller-diameter portion of the tapered hole (21), and when the tool bit is at a position near the magnet (4), the shaft stop (5) is located at a larger-diameter portion of the tapered hole (21).

9. The high-intensity magnetic bit extension rod with a telescopic unlocking function according to claim 1, wherein the connecting rod handle (6) is connected to the connecting rod sleeve (1) and the slidable limiting tubing (2) by a connecting rod handle tube connecting section (61), an outer diameter of the connecting rod handle tube connecting section (61) is larger than that of a tool connecting end of the connecting rod handle (6), an outer portion of the connecting rod handle tube connecting section (61) is connected to the connecting rod sleeve (1) through form locking, and a shaft stop (5) limits an axial position of the connecting rod sleeve (1).

10. The high-intensity magnetic bit extension rod with a telescopic unlocking function according to claim 5, wherein a minimum outer diameter of a connecting rod handle tube connecting section (61) is larger than a diameter of the magnet (4), and the diameter of the magnet (4) is larger than a minimum outer diameter of the connected tool bit.

11. The high-intensity magnetic bit extension rod with a telescopic unlocking function according to claim 1, wherein the connecting rod sleeve (1) is made of a non-conducting magnet material, and the connecting rod handle (6) is made of a conducting magnet material.

12. The high-intensity magnetic bit extension rod with a telescopic unlocking function according to claim 5, wherein a material of the fixed stop (3) is iron, and the spacer (8) is made of a non-magnetically conductive material.

13. The high-intensity magnetic bit extension rod with a telescopic unlocking function according to claim 2, wherein the partition structure is configured to constrain a depth by which the tool bit is inserted into the tool bit sleeve (11), and the partition structure comprises one or a combination of a plurality of a fixed stop (3), an inner hole annular partition (7), and a positioning pin partition that are fixed at the bottom of the tool bit sleeve (11).

14. The high-intensity magnetic bit extension rod with a telescopic unlocking function according to claim 2, wherein the connecting rod handle (6) is connected to the connecting rod sleeve (1) and the slidable limiting tubing (2) by a connecting rod handle tube connecting section (61), an outer diameter of the connecting rod handle tube connecting section (61) is larger than that of a tool connecting end of the connecting rod handle (6), an outer portion of the connecting rod handle tube connecting section (61) is connected to the connecting rod sleeve (1) through form locking, and a shaft stop (5) limits an axial position of the connecting rod sleeve (1).

15. The high-intensity magnetic bit extension rod with a telescopic unlocking function according to claim 2, wherein the connecting rod sleeve (1) is made of a non-conducting magnet material, and the connecting rod handle (6) is made of a conducting magnet material.
